(19) United States
(12) Patent Application Publication
(10) Pub. No.: US 2015/0302715 A1
(43) Pub. Date: Oct. 22, 2015

(54) INTELLECTUAL AT-HOME CARE SYSTEM

(71) Applicant: Wen-Sung Lee, Taichung City (TW)

(72) Inventor: Wen-Sung Lee, Taichung City (TW)

(21) Appl. No.: 14/258,035

(22) Filed: Apr. 22, 2014

(51) Int. Cl. G08B 21/02

(52) U.S. Cl. CPC G08B 21/02

(57) ABSTRACT

An at-home care system includes a monitoring center having a data base which stores the time data, the position data and the identity data sent from the time unit, the positioning unit and the identity verifying unit. The calculation unit calculate the data to generate a warning information. The warning unit and the calculation unit transmit signals by wires or wireless. The warning unit receives the warning information. The monitoring center judges the time-period-of-stay of the user in an independent room according to the position data and the time data, and sends a warning notice.

### BACKGROUND OF THE INVENTION

1. Fields of the Invention

The present invention relates to an intellectual at-home care system, and more particularly, to an intellectual at-home care system wherein the user does not need to wear any device.

2. Descriptions of Related Art

The conventional at-home care system generally comprises a wearing device and the user has to wear the wearing device all the time. The wearing device is electrically connected to a computer which has a data base in which the information of the user is stored. Several pre-set parameters are set in the data base so as to be compared with the instant information from the user. A monitoring device comprises a portable device for obtaining the information of the user, and a calculation unit for calculating and comparing the information of the user obtained by the portable device with the pre-set parameters of the data base to judge the instant status of the user. By this way, the user can be judged to be in a normal or abnormal status.

Nevertheless, the wearing device has to be removed from the user when the user changes clothes and/or taking a shower. This may cause inconveniences to the user, and the information will be stopped when the wearing device is removed. Besides, the wearing device has a certain weight which makes the user feel uncomfortable.

The present invention intends to provide an intellectual at-home care system wherein the user does not need to wear any device.

### SUMMARY OF THE INVENTION

The present invention relates to an at-home care system and comprises a monitoring center having a data base, a calculation unit, a time unit, a positioning unit and an identity verifying unit. The time unit, the positioning unit and the identity verifying unit respectively sending at least one time data, at least one position data and at least one identity data to the data base to be stored. The calculation unit is connected to the data base and reads and calculates the data in the data base so as to generate a warning information.

A warning unit and the calculation unit transmit signals by wires or wireless. The warning unit generates at least one warning signal when receiving the warning information. The monitoring center judges a time-period-of-stay for a user in an independent room according to the at least one position data and the at least one time data. When the time-period-of-stay is judged to be normal, the monitoring center does not send the warning information. When the time-period-of-stay is judged to be abnormal, the calculation unit sends the warning information. The warning unit receives the warning information and sends a warning notice.

Preferably, the data base stores at least one parameter of abnormal time-period-of-stay. The calculation unit calculates the at least one time data in the data base and generates a parameter of instant time-period-of-stay. The calculation unit compares the parameter of instant time-period-of-stay with the at least one parameter of abnormal time-period-of-stay. When the parameter of instant time-period-of-stay is located within the range of the at least one parameter of abnormal time-period-of-stay, the calculation unit generates the warning information. When the parameter of instant time-period-of-stay is not located within the range of the at least one parameter of abnormal time-period-of-stay, the calculation unit generates a safety information,

Preferably, a heat source detection module is connected to the calculation unit by wires or wireless. The heat source detection module detects a user and generates a body-temperature data. The data base stores a normal range of body-temperature. The calculation unit compares the body-temperature data with the normal range of body-temperature. When the body-temperature data is not located within the normal range of body-temperature, the calculation unit generates the warning data.

Preferably, the monitoring center comprises a display unit which is electrically connected to the calculation unit to display the position, the identity, the body temperature and the instant status of the user.

Preferably, the monitoring center comprises a transmission unit which is electrically connected to the calculation unit. The transmission unit sends at least one time data, at least one position data, at least one identity data, the at least one body temperature data and the warning information.

Preferably, a portable device receives the at least one time data, the at least one position data, the at least one identity data, the at least one body temperature data and the warning information from the transmission unit. The portable device has a display interface which displays the identity, the body temperature, the position, the instant time and the warning signal of the user.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the components of the at-home care system of the present invention;

FIG. 2 illustrates the operation status of the at-home care system of the present invention;

FIG. 3 illustrates the components of the second embodiment of the at-home care system of the present invention;

FIG. 4 illustrates the display unit of the monitoring center of the at-home care system of the present invention;

FIG. 5 shows that an emergency notice is displayed on the display unit of the monitoring center of the at-home care system of the present invention, and

FIG. 6 shows that a portable device is used to operate the at-home care system of the present invention.

### DETAILED DESCRIPTION OF THE PREFERRED EMBODIMENT

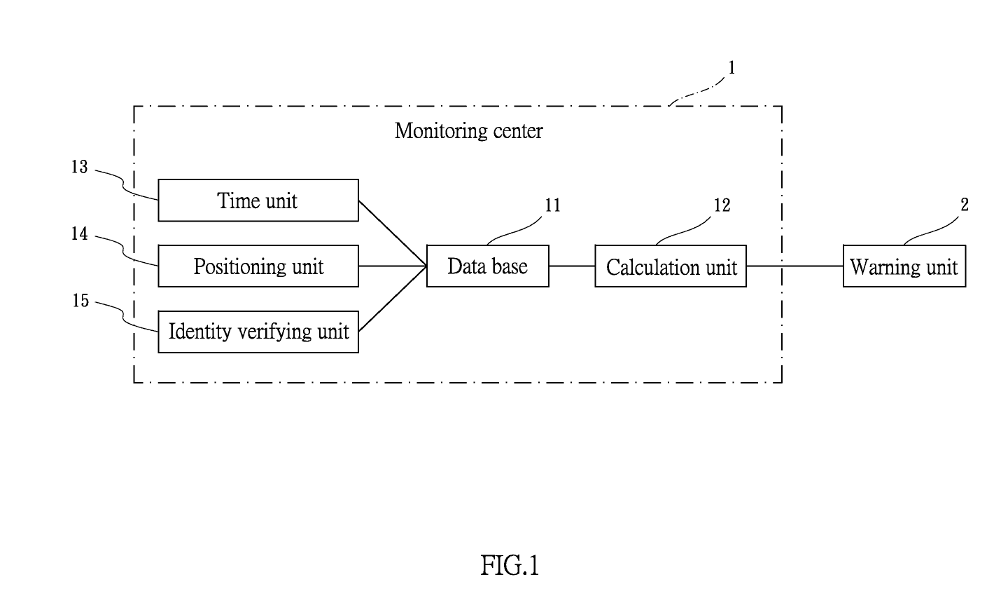

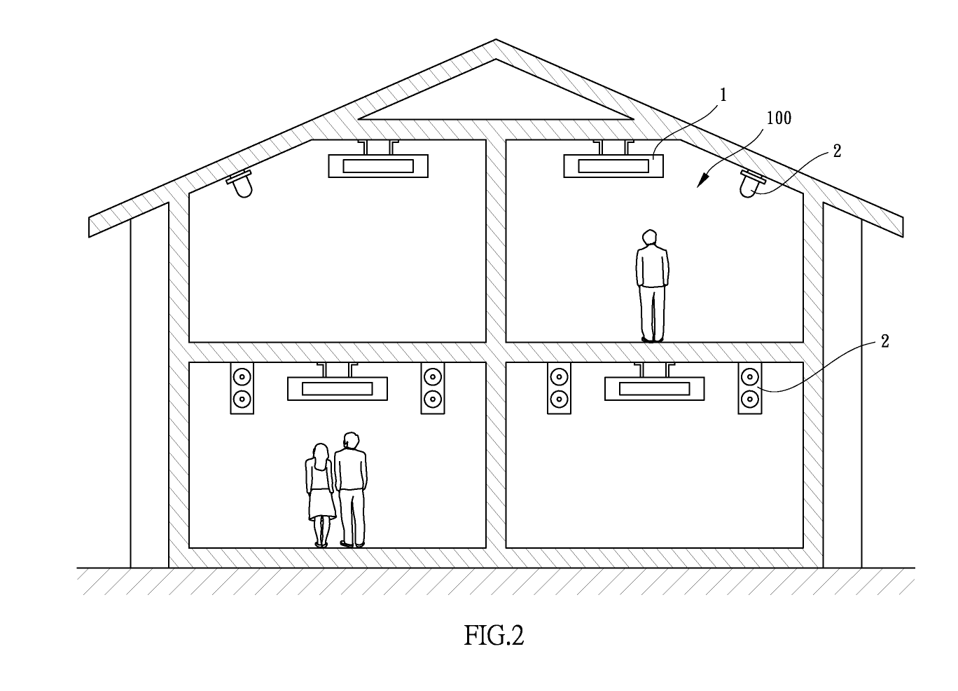

Referring to FIGS. 1 to 2, the at-home care system of the present invention is installed in an independent room 100 which can be living room, bed room, bath room, dining room, or stair ways. The at-home care system comprises a monitoring center 1 which has a data base 11, a calculation unit 12, a time unit 13, a positioning unit 14 and an identity verifying unit 15. The time unit 13, the positioning unit 14 and the identity verifying unit 15 respectively send at least one time data, at least one position data and at least one identity data to the data base 11 to be stored. The calculation unit 12 is connected to the data base 11 and reads and calculates the data in the data base 11 to generate a warning information or a safety information.

A warning unit 2 and the calculation unit 12 transmit signals by wires or wireless. The warning unit 2 generates at least one warning signal when receiving the warning information. The warning signal can be audio or signals, or transmission of reminders. The monitoring center 1 judges the time-period-of-stay for a user in the independent room 100 according to the at least one position data and the at least one time data. When the time-period-of-stay is judged to be normal, the monitoring center 1 does not send the warning information. When the time-period-of-stay is judged to be abnormal, the calculation unit 12 sends the warning information. The warning unit 2 receives the warning information and sends a warning notice to assistance people.

By judging the time-period-of-stay in the independent room 100, the warning unit 2 properly responds to let the assistance people to react with regard the status of the user. Therefore, the user can be taken care in time.

The independent room 100 may have multiple users who are identified by the respective identity verifying unit 15.

Therefore, the users do not need to wear any device and the abnormal situations are acknowledged by the assistance people.

The data base 11 stores at least one parameter of abnormal time-period-of-stay. The calculation unit 12 calculates the at least one time data in the data base 11 and generates a parameter of instant time-period-of-stay, the calculation unit 12 then compares the parameter of instant time-period-of-stay with the at least one parameter of abnormal time-period-of-stay. When the parameter of instant time-period-of-stay is located within the range of the at least one parameter of abnormal time-period-of-stay, the calculation unit 12 generates the warning information. When the parameter of instant time-period-of-stay is not located within the range of the at least one parameter of abnormal time-period-of-stay, the calculation unit 12 generates a safety information. Each of the independent rooms 100 is designed to be correspondent to different parameters of abnormal time-period-of-stay.

For example, assume that the user stays on the balcony from 10:00 in the morning, and the user is detected to be still on the colony at 6:00 in the afternoon, the whole period of time is 8 hours which is the parameter of instant time-period-of-stay. The parameter of instant time-period-of-stay is located within the range of parameter of abnormal time-period-of-stay, so that the calculation unit 12 sends a warning information (this situation means that the user loses consciousness on the balcony). Besides, the different independent rooms 100 have different parameters of abnormal time-period-of-stay. For the previous example, the parameter of abnormal time-period-of-stay is set to be 7 hours, the user stays continuously for 8 hours, so that the warning information is sent. Another example for the independent room is the stair ways. The general time required for going up or down the stairs is 15 seconds, so that the time data is set to be less than 15 seconds or more than 15 seconds. Assume that the user goes down the stairs for only 5 seconds which is the parameter of instant time-period-of-stay. The parameter of instant time-period-of-stay is located within the range of parameter of abnormal time-period-of-stay, so that the calculation unit 12 sends a warning information (this situation means that the user falls down the stairs).

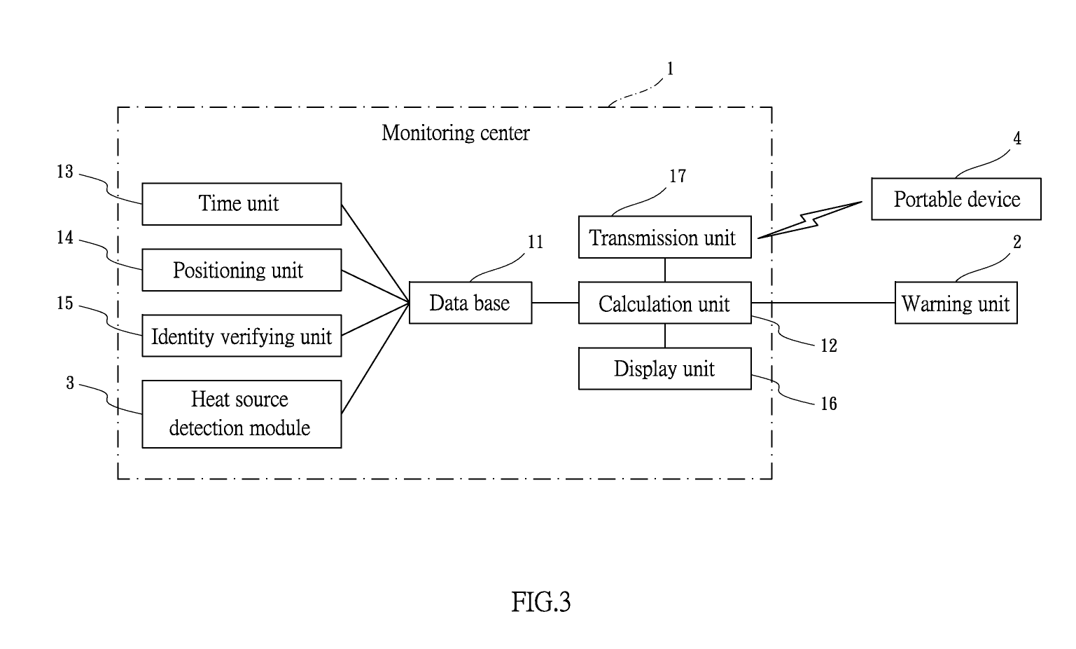

Referring to FIG. 3, the system further comprises a heat source detection module 3 which is connected to the calculation unit 12 by wires or wireless. The heat source detection module 3 detects a user and generates a body-temperature data. The data base 11 stores a normal range of body-temperature. The calculation unit 12 compares the body-temperature data with the normal range of body-temperature, when the body-temperature data is not located within the normal range of body-temperature, the calculation unit 12 generates the warning data. The at-home care system has dual functions which detects the situation of the user by the instant time-period-of-stay and by the body temperature. For example, assume that the normal range of the body temperature is 35 to 37 degrees Celsius, if the temperature of the user is higher than 37.5 degrees Celsius, or lower than 35 degrees Celsius, the user is deemed as in an abnormal situation and the calculation unit 12 generates a warning information. The assistance people can provide assistance.

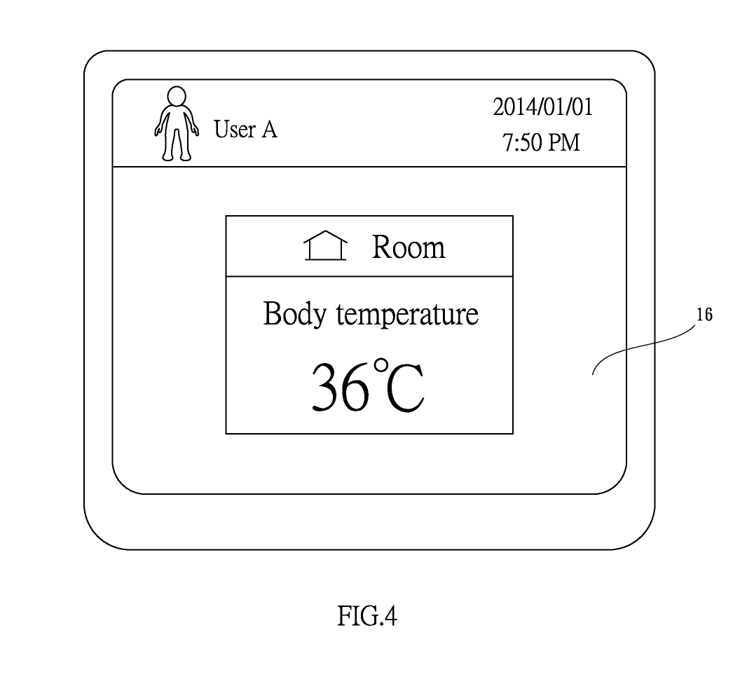

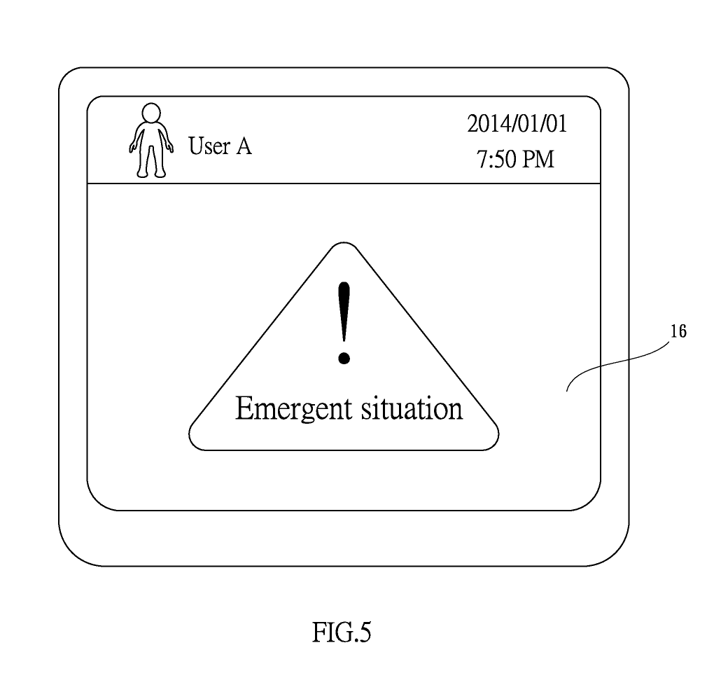

As shown in FIGS. 3 to 5, the monitoring center 1 further comprises a display unit 16 which is electrically connected to the calculation unit 12 to display position, identity, body temperature and instant status of the user. Both of the user and the assistance people can see the situation or status of the user by the display unit 16.

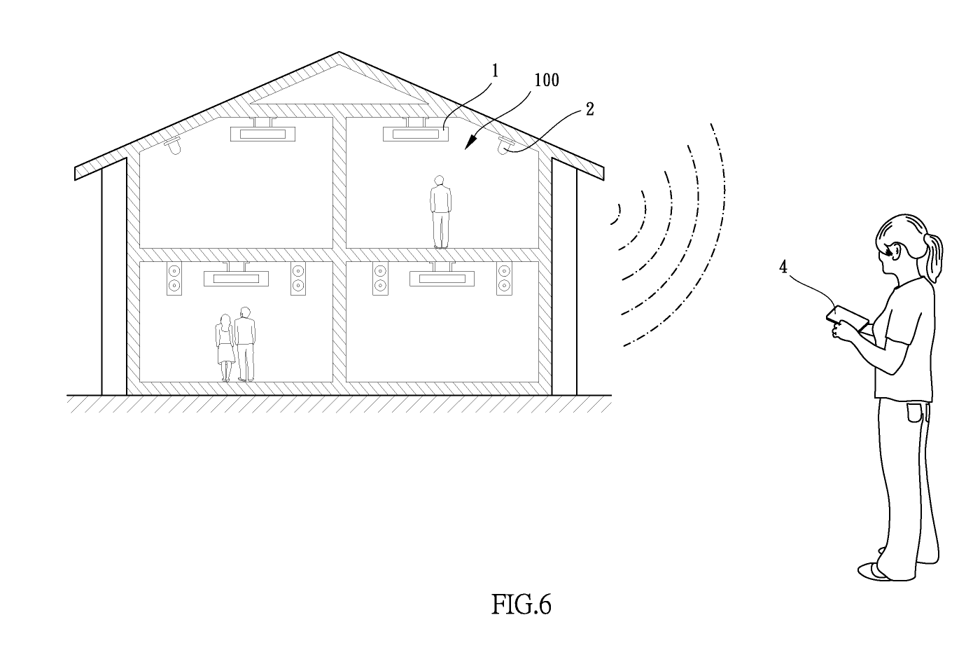

As shown in FIGS. 3 to 6, the monitoring center 1 comprises a transmission unit 17 which is electrically connected to the calculation unit 12. The transmission unit 17 sends at least one time data, at least one position data, at least one identity data, the at least one body temperature data and the warning information. These data is received by a portable device 4 which receives the at least one time data, the at least one position data, the at least one identity data, the at least one body temperature data and the warning information from the transmission unit 17. The portable device 4 can be a smart phone and has a display interface 41 which displays the identity, the body temperature, the position, the instant time and the warning signal of the user. Therefore, the assistance people can get the information of the user by the portable device 4.

While we have shown and described the embodiment in accordance with the present invention, it should be clear to those skilled in the art that further embodiments may be made without departing from the scope of the present invention.

What is claimed is:

1. An at-home care system comprising:
a monitoring center having a data base, a calculation unit, a time unit, a positioning unit and an identity verifying unit, the time unit, the positioning unit and the identity verifying unit respectively sending at least one time data, at least one position data and at least one identity data to the data base to be stored, the calculation unit connected to the data base and reading and calculating the data in the data base so as to generate a warning information;
a warning unit and the calculation unit transmitting signals by wires or wireless, the warning unit generating at least one warning signal when receiving the warning information, and
the monitoring center judging a time-period-of-stay for a user in an independent room according to the at least one position data and the at least one time data, when the time-period-of-stay is judged to be normal, the monitoring center does not send the warning information, when the time-period-of-stay is judged to be abnormal, the calculation unit sends the warning information, the warning unit receives the warning information and sends a warning notice.

2. The at-home care system as claimed in claim 1, wherein the data base stores at least one parameter of abnormal time-period-of-stay, the calculation unit calculates the at least one time data in the data base and generates a parameter of instant time-period-of-stay, the calculation unit compares the parameter of instant time-period-of-stay with the at least one parameter of abnormal time-period-of-stay, when the parameter of instant time-period-of-stay is located within a range of the at least one parameter of abnormal time-period-of-stay, the calculation unit generates the warning information, when the parameter of instant time-period-of-stay is not located within the range of the at least one parameter of abnormal time-period-of-stay, the calculation unit generates a safety information.

3. The at-home care system as claimed in claim 1, wherein a heat source detection module is connected to the calculation unit by wires or wireless, the heat source detection module detects a user and generates a body-temperature data, the data base stores a normal range of body-temperature, the calculation unit compares the body-temperature data with the normal range of body-temperature, when the body-temperature data is not located within the normal range of body-temperature, the calculation unit generates the warning data.

4. The at-home care system as claimed in claim 2, wherein a heat source detection module is connected to the calculation unit by way of wires or wireless, the heat source detection module detects a user and generates a body-temperature data, the data base stores a normal range of body-temperature, the calculation unit compares the body-temperature data with the normal range of body-temperature, when the body-temperature data is not located within the normal range of body-temperature, the calculation unit generates the warning data.

5. The at-home care system as claimed in claim 3, wherein the monitoring center comprises a display unit which is electrically connected to the calculation unit to display position, identity, body temperature and instant status of the user.

6. The at-home care system as claimed in claim 3, wherein the monitoring center comprises a transmission unit which is electrically connected to the calculation unit, the transmission unit sends at least one time data, at least one position data, at least one identity data, the at least one body temperature data and the warning information.

7. The at-home care system as claimed in claim 6 further comprising a portable device which receives the at least one time data, the at least one position data, the at least one identity data, the at least one body temperature data and the warning information from the transmission unit, the portable device has a display interface which displays the identity, the body temperature, the position, the instant time and the warning signal of the user.
